(19) United States
(12) Patent Application Publication
(10) Pub. No.: US 2018/0281378 A1
(43) Pub. Date: Oct. 4, 2018

(54) CENTER DRUM TYPE GRAVURE PRINTING APPARATUS, AND GRAVURE PRINTING METHOD AND METHOD OF MANUFACTURING PRINTED MATTER USING SAID APPARATUS

(71) Applicant: THINK LABORATORY CO., LTD., Chiba (JP)

(72) Inventor: Tatsuo SHIGETA, Chiba (JP)

(21) Appl. No.: 15/763,274

(22) PCT Filed: Aug. 3, 2016
(86) PCT No.: PCT/JP2016/072809

§ 371 Date: Mar. 26, 2018

(30) Foreign Application Priority Data
Sep. 28, 2015 (JP) 2015-190222

(51) Int. Cl. B41F 13/11; B41M 1/10

(52) U.S. Cl. CPC B41F 13/11; B41M 1/10

(57) ABSTRACT

Provided are a center drum type gravure printing apparatus comprising a plurality of gravure plate cylinders, which generates no volatile organic compound, eliminates printing misregistration, requires only a small installation space, and is suitable for performing multi-color printing, and a gravure printing method and a method of manufacturing a printed matter, which use the center drum type gravure printing apparatus. The center drum type gravure printing apparatus, comprises: a center drum; a guiding means for guiding a material to be printed, the guiding means being configured to introduce the material to be printed to a drum surface of the center drum, and being configured to deliver the material to be printed from the drum surface; a plurality of gravure plate cylinders arranged, each of the plurality of gravure plate cylinders having a plate surface with gravure cells; an ink chamber arranged to the plate surface of the each of the plurality of gravure plate cylinders so as to supply an electron beam curable ink to the gravure cells of the each of the plurality of gravure plate cylinders; and an electron beam irradiation means for curing the ink transferred from the gravure cells supplied with the ink to the material to be printed, the electron beam irradiation means being positioned on a downstream side of the material to be printed, which is being guided.

### TECHNICAL FIELD

The present invention relates to a center drum type gravure printing apparatus comprising a plurality of gravure plate cylinders, which is suitable for multi-color printing with respect to a material to be printed, and to a gravure printing method and a method of manufacturing a printed matter, which use the center drum type gravure printing apparatus.

### BACKGROUND ART

In gravure printing, minute recesses (gravure cells) are formed in a gravure plate cylinder (gravure cylinder) in accordance with plate making information to make a plate surface, and an ink is filled in the gravure cells and transferred to a material to be printed. In a general gravure plate-making roll, plate making (making of a plate surface) is completed through the processes of providing a copper-plating layer (plate material) for forming a plate surface to a surface of a plate base material made of, for example, aluminum or iron, forming a large number of minute recesses (gravure cells) in the copper-plating layer in accordance with plate making information by etching, and then forming a hard chromium layer by chromium plating for increasing plate durability of the gravure plate cylinder to provide a surface reinforcing coating layer.

Further, the applicant of the present application has proposed a novel center drum type gravure printing apparatus comprising a plurality of gravure plate cylinders each having a cushion property, which eliminates printing misregistration, requires only a small installation space, and is suitable for performing multi-color printing (Patent Document 1).

Meanwhile, in recent years, in order to eliminate generation of a volatile organic compound, there is also disclosed a radiation curable liquid ink that contains no volatile solvent and is cured with a radiation, for example, an electron beam (Patent Document 2).

### PRIOR ART DOCUMENTS

### Patent Document

### Patent Document 1: JP 2009-96189 A

### Patent Document 2: JP 2010-222580 A

### Patent Document 3: JP 2012-154964 A

### SUMMARY OF THE INVENTION

### Problems to be Solved by the Invention

The present invention has an object to provide a center drum type gravure printing apparatus comprising a plurality of gravure plate cylinders, which generates no volatile organic compound, eliminates printing misregistration, requires only a small installation space, and is suitable for performing multi-color printing, and a gravure printing method and a method of manufacturing a printed matter, which use the center drum type gravure printing apparatus.

### Means for Solving Problems

In order to achieve the above-mentioned object, a center drum type gravure printing apparatus according to the present invention comprises: a center drum that has a large diameter and is rotatable; a guiding means for guiding a material to be printed, the guiding means being configured to introduce the material to be printed to a drum surface of the center drum so that the material to be printed is brought into contact with the drum surface, and being configured to deliver the material to be printed from the drum surface; a plurality of gravure plate cylinders arranged so as to be brought into abutment against a surface of the material to be printed, which is guided to the drum surface of the center drum, each of the plurality of gravure plate cylinders having a plate surface with gravure cells; an ink chamber arranged to the plate surface of the each of the plurality of gravure plate cylinders so as to supply an electron beam curable ink to the gravure cells of the each of the plurality of gravure plate cylinders; and an electron beam irradiation means for curing the ink transferred from the gravure cells supplied with the ink to the material to be printed, the electron beam irradiation means being positioned on a downstream side of the material to be printed, which is being guided.

With the center drum type gravure printing apparatus according to the present invention, the ink is cured through irradiation of an electron beam, and hence it is not necessary that the ink contain a volatile organic compound. Therefore, the volatile organic compound is not generated, and the burden on the environment is small. Further, the ink is cured through irradiation of the electron beam, and hence there is an advantage in that it is not necessary to provide drying means.

It is preferred that the gravure cells each have a depth of from 1 μm to 100 μm, more preferably from 1 μm to 25 μm, further preferably from 1 μm to 10 μm. This is because the ink can be cured faster when the depth of the gravure cell is smaller. When the plate is reduced in thickness as described above, there is also an advantage in that the amount of the ink to be used for printing can be reduced.

A gravure printing method according to the present invention comprises transferring an ink to a material to be printed and curing the ink with the electron beam irradiation means through use of the center drum type gravure printing apparatus.

A method of manufacturing a printed matter according to the present invention comprises transferring an ink to a material to be printed and curing the ink with the electron beam irradiation means through use of the center drum type gravure printing apparatus, to thereby manufacture a printed matter.

A printed matter according to the present invention is manufactured through use of the method of manufacturing a printed matter.

### Advantageous Effects of the Invention

The present invention exhibits a great effect of providing the center drum type gravure printing apparatus comprising a plurality of gravure plate cylinders, which generates no volatile organic compound, eliminates printing misregistration, requires only a small installation space, and is suitable for performing multi-color printing, and the gravure printing method and the method of manufacturing a printed matter, which use the center drum type gravure printing apparatus.

### BRIEF DESCRIPTION OF DRAWINGS

FIG. 1 is a sectional explanatory view for illustrating one embodiment of a center drum type gravure printing apparatus according to the present invention.

FIG. 2 is a sectional explanatory view for illustrating another embodiment of a center drum type gravure printing apparatus according to the present invention.

### MODES FOR CARRYING OUT THE INVENTION

Embodiments of the present invention are described below. However, those embodiments are described as examples, and as a matter of course, various modifications may be made thereto without departing from the technical spirit of the present invention. In addition, the same members are denoted by the same reference symbols.

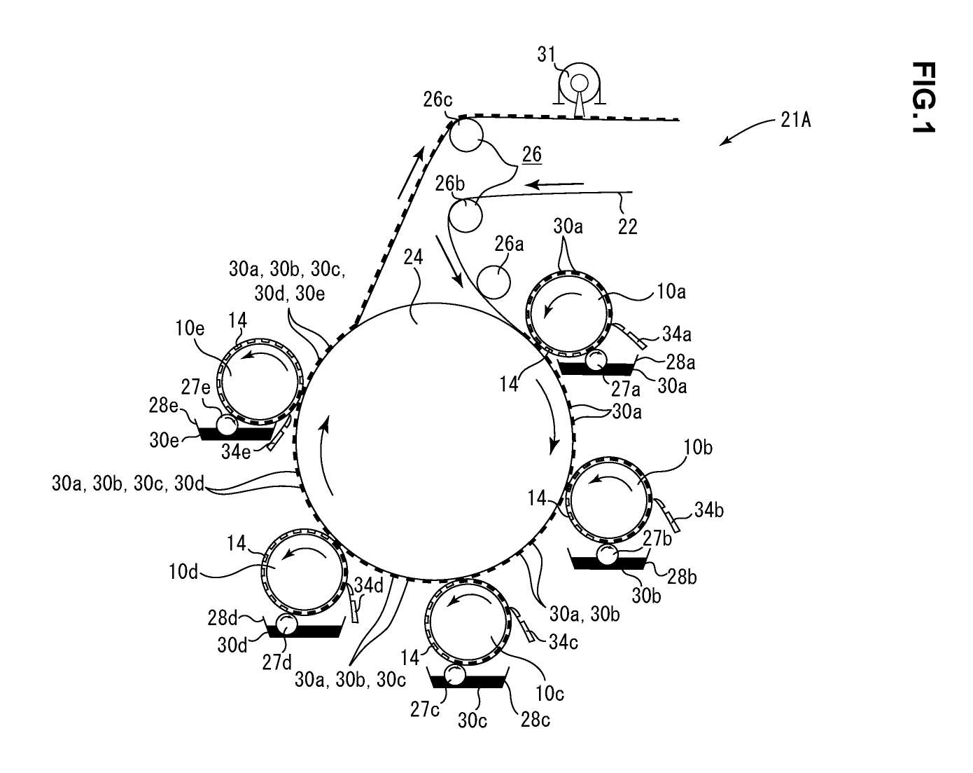

FIG. 1 is a sectional explanatory view for illustrating one embodiment of a center drum type gravure printing apparatus according to the present invention.

In FIG. 1, there is illustrated a center drum type gravure printing apparatus 21A according to the present invention, which is capable of efficiently performing multi-color printing with respect to a film-like material 22 to be printed, for example, a paper sheet or a plastic sheet. The center drum type gravure printing apparatus 21A comprises a center drum 24 that has a large diameter and is rotatable. A guiding means 26 for the material to be printed, which is arranged close to the surface of the center drum 24, comprises introduction rolls 26a and 26b and a delivery roll 26c. The introduction rolls 26a and 26b perform an action of guiding the material 22 to be printed by introducing the material 22 to be printed to a drum surface of the center drum 24 so that the material 22 to be printed is brought into contact with the drum surface. The delivery roll 26c performs an action of guiding the material 22 to be printed by delivering the material 22 to be printed from the drum surface.

A plurality of (five in the example of FIG. 1) gravure plate cylinders 10a to 10e are arranged so as to be brought into abutment against the surface of the material 22 to be printed, which is guided to the drum surface of the center drum 24, and each have a plate surface with gravure cells 14. For convenience of description, the gravure plate cylinders 10a to 10e are sometimes referred to as a first gravure plate cylinder 10a, a second gravure plate cylinder 10b, a third gravure plate cylinder 10c, and a fourth gravure plate cylinder 10d, and a fifth gravure plate cylinder 10e in the following description.

As a manner of forming the gravure cells 14 of the gravure plate cylinder, any of known methods of forming gravure cells may be used. The known methods for forming gravure cells can be applied to a gravure plate cylinder having a plate surface made by a plate making method, for example, a conventional method, a net gravure method, or an electronic engraving method. The known methods for forming gravure cells can also be applied to a gravure plate cylinder having a plate surface made by a plate making method (so-called liftoff method) disclosed in Patent Document 3. Further, the known methods for forming gravure cells can be applied to a gravure plate cylinder having a cushion property disclosed in Patent Document 1.

Further, it is preferred that the gravure cells 14 of the gravure plate cylinder be coated with a reinforcing coating layer. As disclosed in Patent Document 1, it is preferred that the reinforcing coating layer be a DLC layer, a silicon dioxide coating film, or a chromium-plating layer, or a layer formed by a film forming technology using a vacuum, such as a chromium sputtering layer, a chromium nitride layer, or a titanium nitride layer. Further, it is preferred that the silicon dioxide coating film be formed through use of a perhydropolysilazane solution as disclosed in Patent Document 1.

With the conventional method and the net gravure method, the cells can be formed through application of a photosensitive film, light exposure, development, and etching (etching method). The electronic engraving method is a method involving directly engraving cells on a cylinder in a mechanical manner through use of an engraving needle. With the method of forming cells by the electronic engraving method, the cells are formed into a square pyramid shape, and hence an ink can be satisfactorily transferred in a highlight portion. With the etching method, the cells are formed into recesses each having a shallow dish shape. Therefore, in a highlight portion having extremely small cells, the cells are clogged with an ink, and hence transfer of an ink is inferior to that of the electronic engraving method. However, the etching method has an advantage in that a crossed portion of screen lines in a most shadowy part is eliminated so that an ink flows through the crossed portion, and the ink can be reliably transferred to the crossed portion. In addition, the contour of a letter can be formed without a jagged outline. Further, the cells in the most shadowy part are also shallow and hence are suitable for printing using an electron beam curable ink. A gravure plate manufactured by a laser plate making method involving exposure of a cylinder to a laser beam is particularly suitable for the center drum type gravure printing apparatus of the present invention. This is because cells having a high resolution and a small depth can be formed.

In the present invention, it is preferred that the gravure cells each have a depth of from 1 μm to 10 μm. The reason for this is that, when the gravure cells each have a large depth, an electron beam curable ink is not easily cured.

First to fifth ink chambers 28a to 28e are arranged so as to supply first to fifth electron beam curable inks 30a to 30e to the gravure cells 14 of the first to fifth gravure plate cylinders 10a to 10e. Furnisher rolls 27a to 27e are immersed into the ink chambers 28a to 28e, and the cells 14 are filled with the inks 30a to 30e through the furnisher rolls 27a to 27e. Doctor blades 34a to 34e rub the plate surfaces of the gravure plate cylinders 10a to 10e to remove a surplus ink.

An electron beam irradiation means 31 is an electron beam irradiation device positioned on a downstream side of the material 22 to be printed, which is being guided, and configured to cure the inks 30a to 30e transferred from the gravure cells 14 supplied with the inks to the material 22 to be printed. The electron beam irradiation means 31 is positioned on a forward side in a rotation direction of the plurality of gravure plate cylinders 10a to 10e, that is, on a downstream side on which the material 22 to be printed is guided and conveyed. The electron beam irradiation means 31 performs an action of irradiating the inks 30a to 30e transferred from the gravure cells 14 to the material 22 to be printed with an electron beam, to thereby cure the inks 30a to 30e. In the example of FIG. 1, the electron beam irradiation means 31 is arranged on a downstream side of the delivery roll 26c.

In the example of FIG. 1, the electron beam irradiation means 31 is arranged above separately from the material 22 to be printed, which is being conveyed, and configured to perpendicularly irradiate the inks 30a to 30e with an electron beam.

As the electron beam curable ink used in the present invention, any gravure ink that is cured through irradiation of an electron beam can be used. For example, the electron beam curable ink disclosed in Patent Document 2 can be used.

Actions of the above-mentioned configuration are described below. The inks 30a to 30e of different colors are supplied and stored into the gravure cells 14 of the plurality of gravure plate cylinders 10a to 10e. In this state, the plurality of gravure plate cylinders 10a to 10e are each rotated. Further, the center drum 24 is rotated, and the material 22 to be printed in contact with the center drum 24 is allowed to travel by the rotation. In this state, the gravure plate cylinders 10a to 10e are brought into abutment against the surface of the material 22 to be printed. The inks 30a to 30e of different colors stored in the gravure cells 14 of the plurality of gravure plate cylinders 10a to 10e are successively transferred to the surface of the material 22 to be printed. The transferred inks 30a to 30e are cured through irradiation of an electron beam with the electron beam irradiation means 31 and printed on the material 22 to be printed.

The case of performing gravure printing of five colors through use of the first to fifth gravure plate cylinders 10a to 10e as in the example of FIG. 1 is further specifically described. The first ink 30a (for example, black (K)) stored in the gravure cells 14 of the first gravure plate cylinder 10a is transferred to the surface of the material 22 to be printed, and the material 22 to be printed is allowed to travel by rotation to the subsequent second gravure plate cylinder 10b.

Then, the second ink 30b (for example, cyan (C)) stored in the gravure cells 14 of the second gravure plate cylinder 10b is transferred to the surface of the material 22 to be printed, and the material 22 to be printed is allowed to travel by rotation to the subsequent third gravure plate cylinder 10c.

Further, the third ink 30c (for example, magenta (M)) stored in the gravure cells 14 of the third gravure plate cylinder 10c is transferred to the surface of the material 22 to be printed, and the material 22 to be printed is allowed to travel by rotation to the subsequent fourth gravure plate cylinder 10d.

Further, the fourth ink 30d (for example, yellow (Y)) stored in the gravure cells 14 of the fourth gravure plate cylinder 10d is transferred to the surface of the material 22 to be printed, and the material 22 to be printed is allowed to travel by rotation to the subsequent fifth gravure plate cylinder 10e.

Finally, the fifth ink 30e (for example, white (W)) stored in the gravure cells 14 of the fifth gravure plate cylinder 10e is transferred to the surface of the material 22 to be printed, and the material 22 to be printed is allowed to travel by rotation. The inks 30a to 30e are cured through irradiation of an electron beam with the electron beam irradiation means 31, and thus gravure printing of predetermined five colors is completed. The material 22 to be printed, having the first ink 30a, the second ink 30b, the third ink 30c, the fourth ink 30d, and the fifth inks 30e printed thereon, is delivered from the center drum 24 through intermediation of the delivery roll 26c. Through the above-mentioned processing performed successively, multi-color gravure printing can be performed on the surface of the material to be printed.

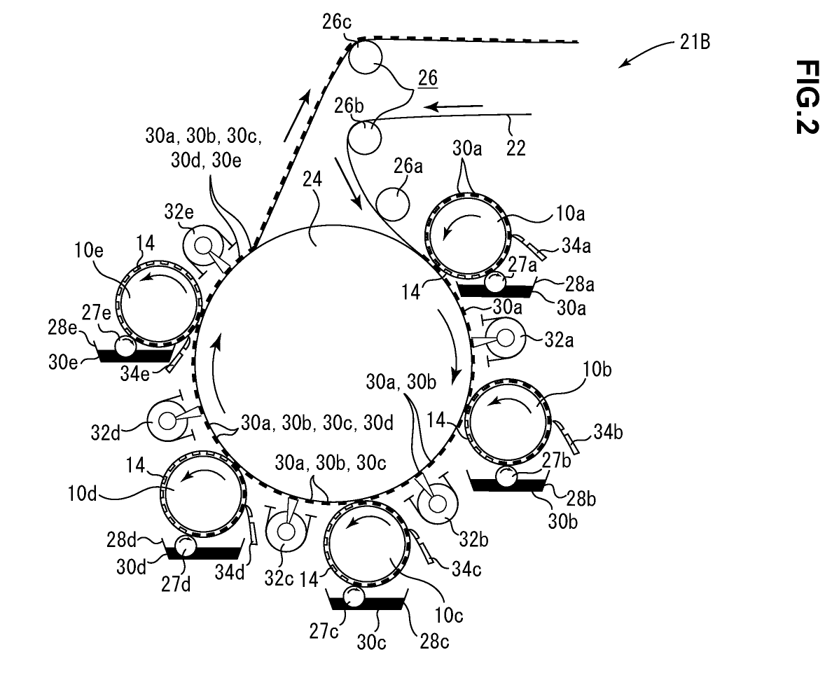

FIG. 2 is a sectional explanatory view for illustrating another embodiment of a center drum type gravure printing apparatus according to the present invention.

In FIG. 2, there is illustrated a center drum type gravure printing apparatus 21B according to the present invention. The center drum type gravure printing apparatus 21B is different from the center drum type gravure printing apparatus 21A of FIG. 1 only in that electron beam irradiation means 32a to 32e are arranged corresponding to the gravure plate cylinders 10a to 10e, respectively, so that the electron beam irradiation means 32a to 32e are adjacent to the plurality of gravure plate cylinders 10a to 10e on a forward side in a rotation direction of the corresponding gravure plate cylinder and are arranged above separately from the drum surface of the center drum 24 so as to be opposed thereto. With this, the center drum type gravure printing apparatus 21B has a configuration in which the inks 30a to 30e transferred from the gravure plate cylinders 10a to 10e to the surface of the material 22 to be printed can be successively cured with the electron beam irradiation means 32a to 32e. In the example of FIG. 2, the electron beam irradiation means 32a to 32e are arranged so as to perpendicularly irradiate the inks 30a to 30e with an electron beam.

As described above, through arrangement of the electron beam irradiation means 32a to 32e corresponding to the gravure plate cylinders 10a to 10e, the inks 30a to 30e can be successively cured and printed as described below. That is, after the first ink 30a is cured, the second ink 30b is cured, and the third ink 30c is cured. Then, the fourth ink 30d is cured, and the fifth ink 30e is cured. Therefore, there is an advantage in that ink bleeding and printing misregistration are reduced.

As described above, also with the center drum type gravure printing apparatus 21B, gravure printing of predetermined five colors is completed through the processes of transferring the electron beam curable inks 30a to 30e to the surface of the material 22 to be printed through use of the first to fifth gravure plate cylinders 10a to 10e, allowing the material 22 to be printed to travel by rotation, and curing the inks 30a to 30e through irradiation of an electron beam with the electron beam irradiation means 31.

In the above-mentioned example, five-color printing is described. However, it is also possible to add colors to perform six-color printing, seven-color printing, or the like. It is also possible to reduce colors to perform three-color printing, four-color printing, or the like.

### REFERENCE SIGNS LIST

10a to 10e: gravure plate (gravure plate cylinder, gravure plate-making roll), 14: gravure cell, 21A, 21B: center drum type gravure printing apparatus according to the present invention, 22: material to be printed, 24: center drum, 26: guiding means, 26a, 26b: introduction roll, 26c: delivery roll, 27a to 27e: furnisher roll, 28a to 28e: ink chamber, 30a to 30e: ink, 31, 32a to 32e: electron beam irradiation means, 34a to 34e: doctor blade.

1. A center drum type gravure printing apparatus, comprising:
a center drum that has a diameter and is rotatable;
a guiding means for guiding a material to be printed, and for introducing the material to be printed to a drum surface of the center drum so that the material to be printed is brought into contact with the drum surface, and for delivering the material to be printed from the drum surface;
a plurality of gravure plate cylinders arranged so as to be brought into abutment against a surface of the material to be printed, which is guided to the drum surface of the center drum, each of the plurality of gravure plate cylinders having a plate surface with gravure cells;
an ink chamber arranged relative to the plate surface of each of the plurality of gravure plate cylinders so as to supply an electron beam curable ink to the gravure cells of each of the plurality of gravure plate cylinders; and
an electron beam irradiation means for curing the electron beam curable ink transferred from the gravure cells supplied with the electron beam curable ink to the material to be printed, the electron beam irradiation means being positioned on a downstream side of the material to be printed, which is being guided.

2. A center drum type gravure printing apparatus according to claim 1, wherein each of the gravure cells has a depth of from 1 μm to 10 μm.

3. A gravure printing method, comprising:
providing a center drum type gravure printing apparatus comprising a rotatable center drum having a diameter and a guiding means for guiding a material to be printed, and for introducing the material to be printed to a drum surface of the center drum so that the material to be printed is brought into contact with the drum surface, and for delivering the material to be printed from the drum surface, the center drum type gravure printing apparatus further comprising a plurality of gravure plate cylinders arranged so as to be brought into abutment against a surface of the material to be printed, which is guided to the drum surface of the center drum, each of the plurality of gravure plate cylinders having a plate surface with gravure cells, the center drum type gravure printing apparatus further comprising an ink chamber arranged relative to the plate surface of each of the plurality of gravure plate cylinders so as to supply an electron beam curable ink to the gravure cells of each of the plurality of gravure plate cylinders, the center drum type gravure printing apparatus further comprising an electron beam irradiation means for curing the electron beam curable ink transferred from the gravure cells supplied with the electron beam curable ink to the material to be printed, the electron beam irradiation means being positioned on a downstream side of the material to be printed, which is being guided;
transferring the electron beam curable ink to the material to be printed and curing the electron beam curable ink with the electron beam irradiation means through use of the center drum type gravure printing apparatus.

4. A method of manufacturing a printed matter, the method comprising:
providing a center drum type gravure printing apparatus comprising a rotatable center drum having a diameter and a guiding means for guiding a material to be printed, and for introducing the material to be printed to a drum surface of the center drum so that the material to be printed is brought into contact with the drum surface, and for delivering the material to be printed from the drum surface, the center drum type gravure printing apparatus further comprising a plurality of gravure plate cylinders arranged so as to be brought into abutment against a surface of the material to be printed, which is guided to the drum surface of the center drum, each of the plurality of gravure plate cylinders having a plate surface with gravure cells, the center drum type gravure printing apparatus further comprising an ink chamber arranged relative to the plate surface of each of the plurality of gravure plate cylinders so as to supply an electron beam curable ink to the gravure cells of each of the plurality of gravure plate cylinders, the center drum type gravure printing apparatus further comprising an electron beam irradiation means for curing the electron beam curable ink transferred from the gravure cells supplied with the electron beam curable ink to the material to be printed, the electron beam irradiation means being positioned on a downstream side of the material to be printed, which is being guided;
transferring the electron beam curable ink to the material to be printed and curing the electron beam curable ink with the electron beam irradiation means through use of the center drum type gravure printing apparatus to thereby manufacture a printed matter.

5. A method according to claim 3, wherein the material to printed and the electron beam curable ink forms a printed matter.

6. A gravure printing method according to claim 3, wherein each of the gravure cells has a depth of from 1 μm to 10 μm.

7. A method according to claim 4, wherein each of the gravure cells has a depth of from 1 μm to 10 μm.
